(19) United States
(12) Patent Application Publication
(10) Pub. No.: US 2010/0211972 A1
(43) Pub. Date: Aug. 19, 2010

(54) SYSTEM AND METHOD FOR DISPLAYING AN EMERGENCY ALERT MESSAGE

(75) Inventors: Jamie Howarter, Overland Park, KS (US); Douglas Ceballos, Olathe, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/370,944

(22) Filed: Feb. 13, 2009

(51) Int. Cl. H04N 7/025

(52) U.S. Cl. 725/33

(57) ABSTRACT

Embodiments of the disclosed invention include a system and a method for displaying an emergency alert message. In one embodiment, a set top box is disclosed that identifies an emergency alert message and determines whether the set top box is currently tuned to a channel that includes displaying of the identified emergency alert message. In response to a determination that the set top box is not currently tuned to a channel that includes displaying of the identified emergency alert message, the set top box retrieves a set of stored user preferences and determines whether to display the identified emergency alert message based on the retrieved user preferences. In response to a determination to display the identified emergency alert message based on the retrieved user preferences, the set top box displays the identified emergency alert message on the display unit in accordance with the user specified preferences.

### CROSS REFERENCE TO RELATED APPLICATION

The present invention is related to the following patent applications: entitled “System And Method For Bypassing An Emergency Alert Break-In”, Ser. No. ______, attorney docket number 11000060-0468; and “System and Method for Bypassing an Emergency Alert Break-In For a Recorded Event”, Ser. No. ______, attorney docket number 11000060-0563; filed even date hereof, assigned to the same assignee, and incorporated herein in its entirety by reference.

### BACKGROUND OF THE INVENTION

The Emergency Alert System is a national public warning system that stems from the desire of the President of the United States to communicate with the public in times of national emergencies. In the early 1960s, the chief executive began allowing local and state authorities to use the system to transmit localized warnings, such as, but not limited to, child abduction emergencies (AMBER alerts) and weather information. The system has been designed to deliver messages quickly and automatically in the event of an emergency. Among its most conspicuous features to the public may be the automatic interruption of broadcast programming that replaces program audio with an aural alert and superimposes a text crawl with warning information at the bottom of the TV screen. In some situations, a local news broadcasting station may completely preempt a regularly scheduled program.

### SUMMARY

Embodiments of the disclosed invention include a system and a method for displaying an emergency alert message. In one embodiment, a set top box is disclosed that identifies an emergency alert system message and determines whether the set top box is currently tuned to a channel that includes displaying of the identified emergency alert system message. In response to a determination that the set top box is not currently tuned to a channel that includes displaying of the identified emergency alert system message, the set top box retrieves a set of stored user preferences and determines whether to display the identified emergency alert system message based on the retrieved user preferences. In response to a determination to display the identified emergency alert system message based on the retrieved user preferences, the set top box displays the identified emergency alert system message on a display unit in accordance with the user specified preferences.

### BRIEF DESCRIPTION OF THE DRAWINGS

Illustrative embodiments of the present invention are described in detail below with reference to the attached drawing figures, which ate incorporated by reference herein and wherein:

FIG. 1 depicts an embodiment of a network environment in which the illustrative embodiments may be implemented;

FIG. 2 depicts an embodiment of a set top box in accordance with the illustrative embodiments;

FIG. 3 depicts an embodiment of a process for displaying an emergency alert system message;

FIG. 4 depicts another embodiment of a process for displaying an emergency alert system message; and

FIG. 5 depicts another embodiment of a process for displaying an emergency alert system message; and

FIG. 6 depicts an embodiment of a user interface for providing a user configurable option for displaying an emergency alert system message in accordance with the disclosed embodiments.

### DETAILED DESCRIPTION

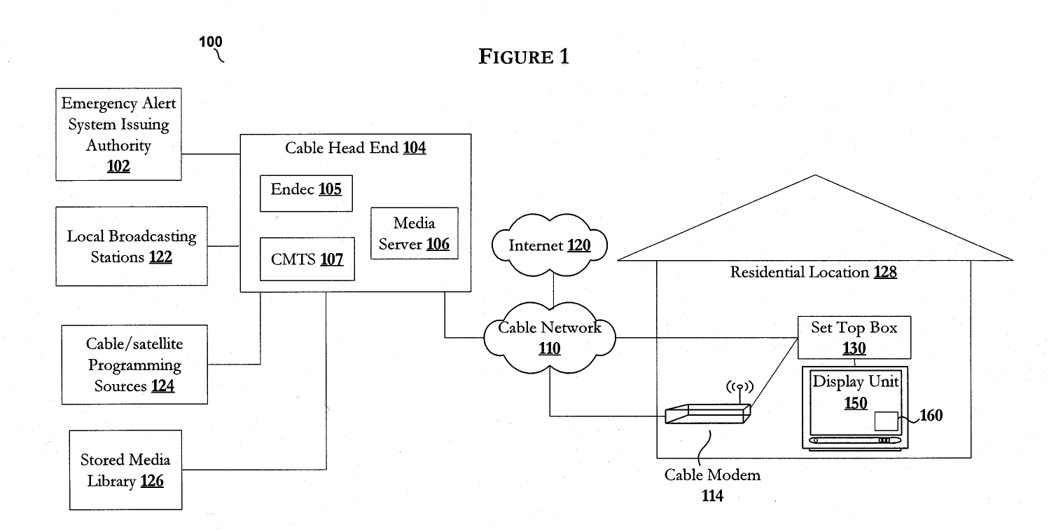

The disclosed embodiments and advantages thereof are best understood by referring to FIGS. 1-6 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented.

The disclosed embodiments recognize deficiencies associated with the current emergency alert system. For example, the disclosed embodiments recognize that an emergency alert system message is displayed only if a viewer is currently watching a local broadcasting channel that is displaying the emergency alert system message. Thus, if a viewer is not currently watching TV, not currently watching live TV, or not currently watching a local broadcasting channel that is displaying the emergency alert system message, the viewer is not notified of the emergency situation. In addition, the disclosed embodiments recognize that some people may prefer that an emergency alert system message not preempt the current displayed programming. Accordingly, the disclosed embodiments provide a user configurable option for notifying and displaying an emergency alert system message while enabling a viewer to continue viewing a desired program. For example, as will be further described, in one embodiment, a user may configure a set top box to monitor for an emergency alert system message on a particular broadcast channel and for activating a picture-in-picture feature associated with a display unit to display the emergency alert broadcasting channel in the second display window. In these embodiments, the user may then switch to the second window, enlarge the second window, and/or close the second window after being notified of the emergency alert system message.

With reference now to FIG. 1, a network environment 100 is presented in which the illustrative embodiments may be implemented for displaying an emergency alert message. As referenced herein, an emergency alert system message means any message, alert, and/or newscast that utilizes the emergency alert system to break-in, interrupt, and/or modify displaying of a television program to present information associated with an urgent and/or important event. In the depicted embodiment, an emergency alert system (EAS) issuing authority 102 sends out an emergency alert system signal that includes information associated with an emergency alert system message. Emergency alert system issuing authority 102 includes national, state, and local authorities. For example, at the national level, the President may activate the emergency alert system. Additionally, the National Weather Service (NWS) and the Federal Emergency Management Agency (FEMA) may also transmit messages using the emergency alert system. At the state and local level, the EAS State Emergency Communications Committee (SECC), Local Emergency Communications Committee (LECC), and local broadcasting stations may transmit alert messages, such as, but not limited to, child abduction emergencies (AMBER alerts) and weather alerts/reports, using the emergency alert system.

One or more cable/satellite head ends, such as, but not limited to, cable head end 104, receives the emergency alert system signal from emergency alert system issuing authority 102 and/or from other broadcasters/cable head ends in the area relaying the information from the originating source. Cable head end 104 is a facility that originates and communicates cable/satellite TV services to a plurality of subscribers, such as, but not limited to, residential location 128 via cable network 110. In some embodiments, cable network 110 may include, but is not limited to, one or more coaxial cable networks, fiber-optic networks, and/or satellite networks. Additionally, in some embodiments, cable network 110 may also include twisted pair networks for providing IPTV cable television-type services.

In one embodiment, cable head end 104 includes an emergency alert system encoder/decoder (endec) 105 for receiving and decoding an emergency alert system signal. In one embodiment, emergency alert system encoder/decoder 105 decodes an emergency alert system signal to determine the emergency type and affected areas associated with the emergency alert system signal. For example, an emergency alert system signal contains codes that identify the key elements of an emergency alert system message, such as, but not limited to, the message originator, the event, the location of the event, and the valid time period of the message.

In some embodiments, emergency alert system encoder/decoder 105 passes the decoded emergency alert system message to a media server 106. In one embodiment, media server 106 includes computer executable instructions and/or electronic components that automatically recognize incoming EAS information and generates the appropriate emergency text crawl and/or other appropriate display information associated with the emergency alert system message for overlaying the emergency alert system message over a television program.

In one embodiment, cable head end 104 utilizing media server 106 and/or other appropriate device encodes a plurality of television programming signals from a variety of input sources, such as, but not limited to, one or more local broadcasting stations 122, cable/satellite programming sources 124, and stored media library 126. In some embodiments, cable head end 104 receives signals broadcasted from local broadcasting stations 122 over the air using cell transmission towers. In addition, in one embodiment, cable head end 104 may encode one or more television signals, such as, but not limited to, signals received from local broadcasting stations 122, with an emergency alert system message in response to receiving an emergency alert system message originating from emergency alert system issuing authority 102.

In some embodiments, cable head end 104 may include a cable modem termination system (CMTS), such as, CMTS 107, for providing high-speed Internet access via a cable modem to subscribers. In one embodiment, CMTS 107 sends and receives digital cable modem signals on cable network 110, such as, but not limited to, receiving signals sent upstream from a subscriber's cable modem, such as, cable modem 114. In some embodiments, CMTS 107 converts the signals into IP packets and routs the signals to an Internet Service Provider for connection to Internet 120. Internet 120 is a massive network of networks that connects millions of computers/electronic devices together globally, forming a network in which any computer/electronic device can communicate with any other computer/electronic device as long as they are both connected to the Internet 120. In addition, in some embodiments, CMTS 107 may also send signals downstream to cable modem 114. In one embodiment, cable modem 114 may be hardwired to set top box 130 for communicating data between set top box 130 and cable modem 114. In some embodiments, cable modem 114 may include a wireless transceiver for communicating data wirelessly to one or more electronic device, such as, but not limited to, set top box 130.

In accordance with the disclosed embodiments, set top box 130 comprises one or more emergency alert system break-in components/modules for displaying an emergency alert message 160 on a display unit 150. As will be further described, in some embodiments, set top box 130 provides a user configurable option for displaying an emergency alert system message. For example, in one embodiment, set top box 130 provides a user configurable option for displaying an emergency alert system message in the event set top box 130 is tuned to a channel frequency not encoded with the emergency alert system and/or set top box 130 is playing a recorded media content file. In these embodiments, a user may choose whether to interrupt the current programming with the emergency alert system message. For instance, in one embodiment, set top box 130 may, in accordance with the user preference, switch to a channel frequency encoded with the emergency alert system message. In another embodiment, set top box 130 may activate a picture-in-picture feature associated with display unit 150 for displaying a channel frequency encoded with the emergency alert system message in a second display window of display unit 150. As referenced herein, picture-in-picture is a feature associated with some display units that is capable of displaying at least two different media content on multiple windows of the display unit. In some embodiments, the second display window may be an inset window of the main display. In other embodiments, the multiple display windows are displayed side-by-side, commonly referred to as picture by picture. Further, in some embodiments, set-top box 130 may generate an emergency alert system overlay image for presenting the emergency alert system on top of the current programming. Accordingly, in some embodiments, a user may continue viewing non-emergency alert system affected programming, e.g., a recorded program and/or a non-local channel, and still receive emergency alert system messages.

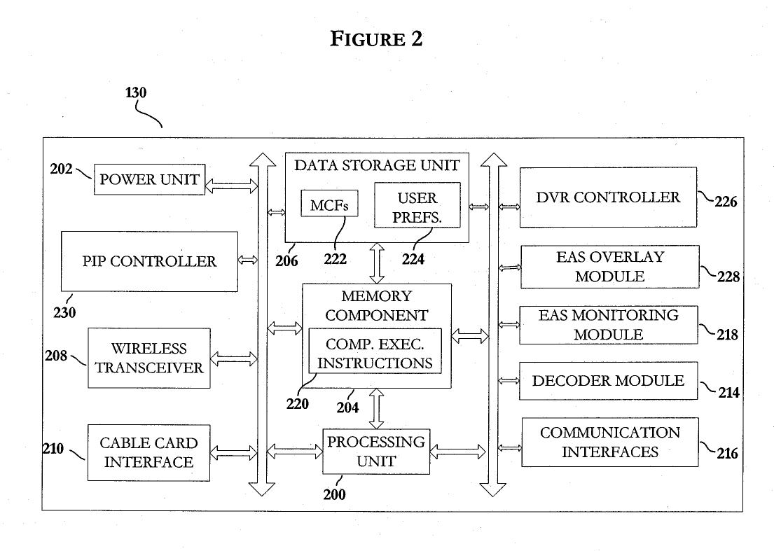

FIG. 2 depicts an embodiment of set top box 130 for displaying an emergency alert message. In the depicted embodiment, set top box 130 comprises, among other components, a processing unit 200, a power unit 202, a memory component 204, a data storage unit 206, a wireless transceiver 208, a cable card interface 210, a cable tuner 214, and a set of communication interfaces 216.

Processing unit 200 may comprise of one or more microprocessors for executing computer usable program code/instructions for providing television programming and for displaying an emergency alert system message. For example, in one embodiment, processing unit 200 executes computer executable instructions 220 stored in memory component 204 for enabling a user configurable option for displaying an emergency alert message.

In some embodiments, memory component 204 is a volatile memory component of set top box 130. Volatile memory is memory that loses its contents when set top box 130 loses power. For example, in some embodiments, memory component 204 may be random access memory (RAM). Random access memory stores currently executing instructions and/or data utilized by an operating system, software program, hardware device, and/or a user.

Data storage unit 206 is a non-volatile memory component of set top box 130, such as, but not limited to, a hard disk drive. Non-volatile memory retains stored data when power is loss. In some embodiments, data storage unit 206 may be an external hard drive and/or a network data storage unit. In some embodiments, data storage unit 206 may store user preferences 224 associated with providing a user configurable option for displaying an emergency alert system message. In addition, in some embodiments, data storage unit 206 may also store media content files 222, such as, but not limited to, television content received from cable head end 104.

For example, in some embodiments, set top box 130 may include a digital video recorder (DVR) controller 226 for recording and playback of media content files 222. In addition, in some embodiments, DVR controller 226 may be utilized for interrupting the playback of media content files 222 for displaying a received emergency alert system message.

In accordance with the disclosed embodiments, set top box 130 includes communication interfaces 216 for receiving media content signals/data from, but not limited to, cable head end 104. In addition, in some embodiments, communication interfaces 216 may provide connection ports for coupling set top box 130 to one or more electronic devices. For example, in one embodiment, communication interfaces 216 includes a video output interface, such as, but not limited to, a coaxial cable connection for coupling set top box 130 to display unit 150. In some embodiments, communication interfaces 216 may include an Ethernet port and/or a telephone line port for connecting set top box 130 to a network device over the telephone network and/or the Internet. Additionally, in some embodiments, set top box 130 may include other connector ports, such as, but not limited to, a 1394 port, a universal serial bus (USB) port, and/or a high-definition multimedia interface (HDMI).

Set top box 130 may also include one or more decoder module 214 for decoding received media content signals, such as, but not limited to, cable television signals received from cable head end 104. For example, in some embodiments, decoder module 214 may be a quadrature amplitude modulation (QAM) tuner. Quadrature amplitude modulation is one format by which digital media content channels are encoded and transmitted by a cable company or a broadcasting station, such as, cable head end 104. A QAM tuner is an electronic tuning device used in digital television sets, set top boxes, DVRs, and other electronic equipment to tune/decode the received media content channels. In some embodiments, decoder module 214 may also be an Advanced Television Systems Committee (ATSC) tuner/receiver for receiving and decoding over the air digital channels.

In accordance with one embodiment, set top box 130 may include an emergency alert system monitoring module 218 for identifying/detecting an emergency alert system message. All emergency alert system messages are required to be digitally encoded with a header, an attention signal, an audio announcement, and a digitally encoded end-of-message marker. The header includes information about who originated the alert (the President, state or local authorities, the National Weather Service, or the broadcaster), a short, general description of the event (tornado, flood, severe thunderstorm), the counties or states affected, the expected duration of the event (in minutes), the date and time it was issued, and an identification of the originating station. The attention signal follows the header and may last between 8 to 25 seconds, depending on the originating station. For example, in some embodiments, commercial broadcasting stations, such as cable head end 104, may broadcast an attention signal consisting of a “two tone” combination of 853 Hz and 960 Hz sine waves. The emergency alert system message ends with three bursts of an end of message indicator, which is the text NNNN, preceded each time by the binary 10101011.

In one embodiment, emergency alert system monitoring module 218 may identify an emergency alert system message transmitted from cable head end 104 by recognizing the header information associated with an emergency alert system message. In other embodiments, emergency alert system monitoring module 218 may identify an emergency alert system message transmitted from cable head end 104 by recognizing the attention signal encoded in one or more broadcast channels. For example, in one embodiment, emergency alert system monitoring module 218 may be a dedicated tuner/decoder that monitors a local broadcast channel for identifying an emergency alert system message broadcast. Alternatively, in some embodiments, emergency alert system monitoring module 218 may be a component of decoder module 214 for identifying an emergency alert system broadcast. For example, in one embodiment, cable head end 104 may encode and transmit the attention signal on all broadcast channels. In these embodiments, decoder module 214, utilizing emergency alert system monitoring module 218, identifies the attention signal and, if necessary and desired based on the user preferences, decoder module 214 may automatically switch/tune to a local broadcasting channel containing the emergency alert system message.

In some embodiments, set top box 130 may also include an emergency alert system overlay module 228. In one embodiment, emergency alert system overlay module 228 may generate an overlay display utilizing the header information associated with an emergency alert system message for displaying information over a portion of a current viewing program. In one embodiment, a user may configure emergency alert system overlay module 228 to display the overlay interface for a specified period. In some embodiments, overlay module 228 may be configured to display and update the overlay interface with updated information associated with the emergency alert system message for the life of the emergency alert system message, i.e., until an end of message indicator is received. In other embodiments, the overlay interface may be closed in response to receiving a user command/request.

In addition, in some embodiments, set top box 130 may include a picture-in-picture (PIP) controller module 230 for activating a picture-in-picture feature associated with display unit 150 for displaying a channel frequency encoded with the emergency alert system message in a second display window of display unit 150. For example, in some embodiments, set top box 130 stores configuration information associated with a plurality of display units. A user or cable installer selects the appropriate settings associated with display unit 150 coupled to set top box 130. For instance, this process is commonly performed to enable a user to utilize one remote control device for controlling the features and functions of set top box 130 and display unit 150. In some embodiments, set top box 130 may utilize infrared (IR) scanning of a remote control device associated with display unit 150 for learning the code/signal for activating the picture-in-picture feature associated with display unit 150.

For example, in one embodiment, set top box 130 may include wireless transceiver 208 for providing short-range data exchange using, but not limited to, infrared light. In some embodiments, wireless transceiver 208 enables a user using a remote control device to operate and configure set top box 130. Additionally, in some embodiments, wireless transceiver 208 enables a user using a remote control device to configure an option for interrupting a current program with a emergency alert system message and for configuring the method by which the interaction occurs, such as, but not limited to, switching over to a emergency alert system message broadcasting channel, displaying an overlay image, or displaying the emergency alert system message broadcasting channel in a second window.

In some embodiments, set top box 130 may include a cable card interface 210 for interfacing with a plug-in cable/smart card that enables viewing and/or recording of cable television programming. For example, in some embodiments, cable card 210 comprises instructions and/or a decryption key for decoding encrypted cable television signals transmitted by cable head end 104.

Set top box 130 may also include a power source, such as, power unit 202. In one embodiment, power unit 202 converts the input power from an AC adaptor to run various components of set top box 130. In addition, in some embodiments, power unit 202 may include an internal power source, such as, but not limited to, a battery component.

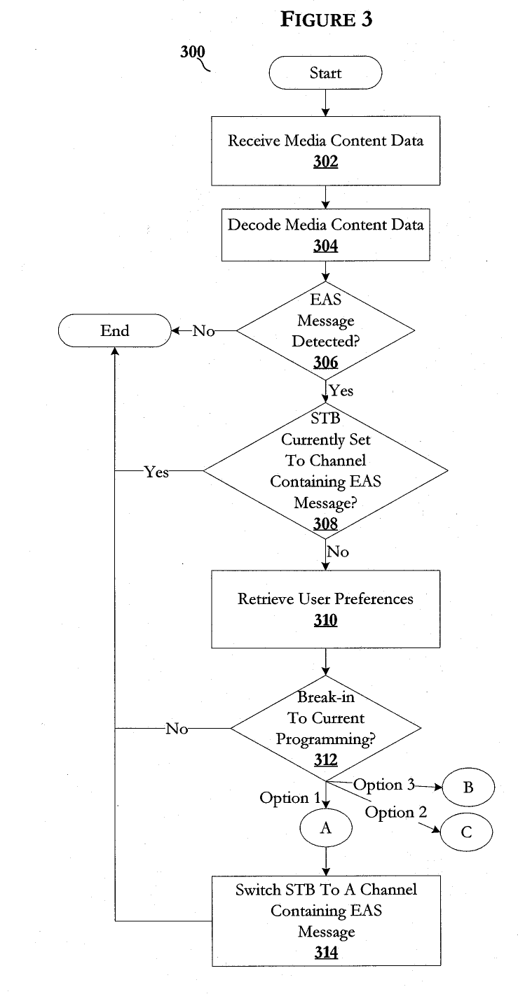

With reference now to FIG. 3, an embodiment of a process 300 for displaying an emergency alert message is disclosed. Process 300 may be executed by a set top box, such as, but not limited to, set top box 130 as depicted in FIG. 2. Process 300 begins by receiving media content data, such as, but not limited to, cable television signals and emergency alert system messages, at step 302. In some embodiments, the media content data may be received via a cable network, such as, but not limited to, cable network 110. Additionally, in some embodiments, the media content data may include an emergency alert system message encoded in one or more cable television signals. Further, in some embodiments, the media content data may include an emergency alert system message that is not encoded with a television signal. For example, in one embodiment, cable head end 104 may transmit an emergency alert system message data to set top box 130 via cable modem 114 independent of a television programming signal.

At step 304, the process decodes the received media content data. The process, at step 306, identifies whether the received media content data includes an emergency alert system message. For example, the process may identify an emergency alert system message transmitted from cable head end 104 by recognizing the header information and/or the attention signal encoded in one or more broadcast channels. If the received media content data does not include an emergency alert system message, the process terminates. However, if the received media content data does include an emergency alert system message, the process, at step 308, determines whether the set top box is currently set to a channel that includes the broadcast emergency alert system message. If the set top box is currently set to a channel that includes the broadcast emergency alert system message, the process terminates. In some embodiments, the set top box may automatically wake up/power on itself and/or a coupled display unit for displaying the broadcast emergency alert system message.

However, if the process determines that the set top box is not currently set to channel that includes the emergency alert system message, the process, at step 310, retrieves one or more user preferences associated with displaying a received emergency alert system message. For example, in some embodiments, the current displayed programming may be a recorded media content file and/or may be a live broadcast of a channel that does not contain the broadcast emergency alert system message. At step 312, the process determines whether to interrupt the current displayed programming based on the retrieved user preferences. If the retrieved user preferences indicate that a user does not prefer to interrupt the current displayed programming with a broadcast emergency alert system message, the process terminates.

However, if the retrieved user preferences indicate that a user wants to interrupt a current displayed programming with a broadcast emergency alert system message, the process may execute one or more actions based on the retrieved user preferences. For example, in one embodiment, the process may, at step 314, switch/tune the set top box to a channel broadcasting the emergency alert system message. In some embodiments, the user may configure the user preferences to specify a particular local broadcasting channel.

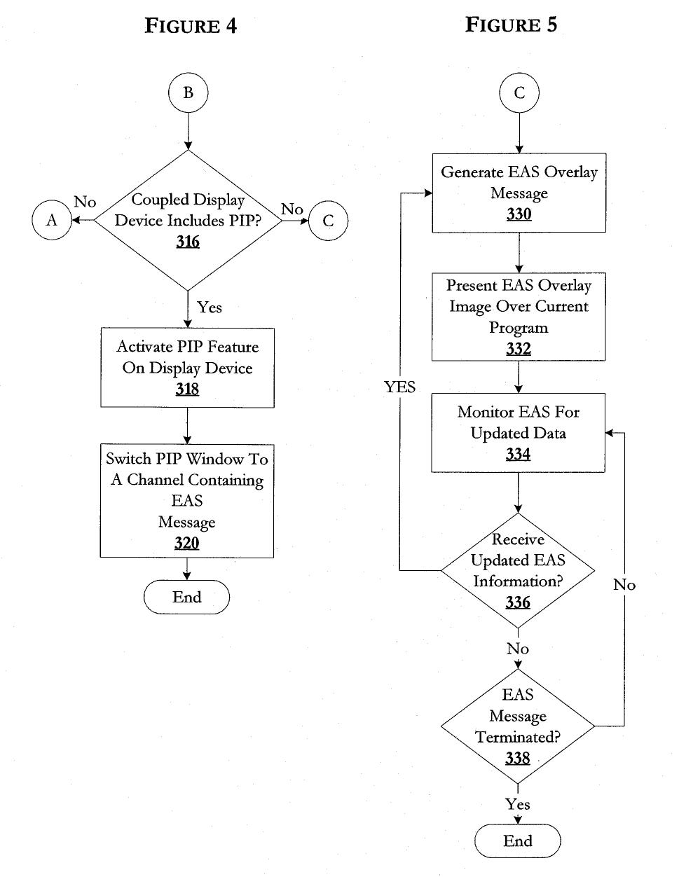

FIG. 4 depicts another embodiment of process 300 for displaying an emergency alert system message. In accordance with the depicted embodiment of FIG. 4, if, at step 312, the process determines that the retrieved user preferences indicate that a user wants to interrupt a current displayed programming with a broadcast emergency alert system message, the process may, at step 316, determine whether a display unit coupled to the respective set top box includes a picture-in-picture feature. In these embodiments, if the process determines that the display unit coupled to the respective set top box includes a picture-in-picture feature, the process, at step 318, activates the picture-in-picture feature on the coupled display unit. At step 320, the process switches/tunes the picture-in-picture window to a channel broadcasting the emergency alert system message, with process 300 terminating thereafter. Depending on the features associated with the coupled display unit, a user may enlarge, switch over, and/or close the picture-in-picture window as desired.

FIG. 5 depicts another embodiment of process 300 for displaying an emergency alert system message. In accordance with the depicted embodiment of FIG. 5, if, at step 312, the process determines that the retrieved user preferences indicate that a user wants to interrupt a current displayed programming with a broadcast emergency alert system message, the process may, at step 330, generate an emergency alert system message overlay interface utilizing the received data associated with an emergency alert system message. For example, in one embodiment, cable head end 104 may transmit just the emergency alert system message data to set top box 130 via cable modem 114.

At step 332, the process presents the generated emergency alert system message overlay interface over a portion of the current programming on the coupled display unit. At step 334, the process monitors for updated information associated with the emergency alert system message. The process, at step 336, determines whether updated information associated with the emergency alert system message is received. In response to receiving updated information associated with the emergency alert system message, the process, at step 330, updates and/or generates an overlay interface depicting the updated emergency alert system message. At step 338, the process determines whether an end of message indicator associated with the broadcast emergency alert system message has been received. If an end of message indicator associated with the broadcast emergency alert system message has not been received, the process returns to step 334. However, if the process determines that an end of message indicator associated with the broadcast emergency alert system message has been received, the process terminates.

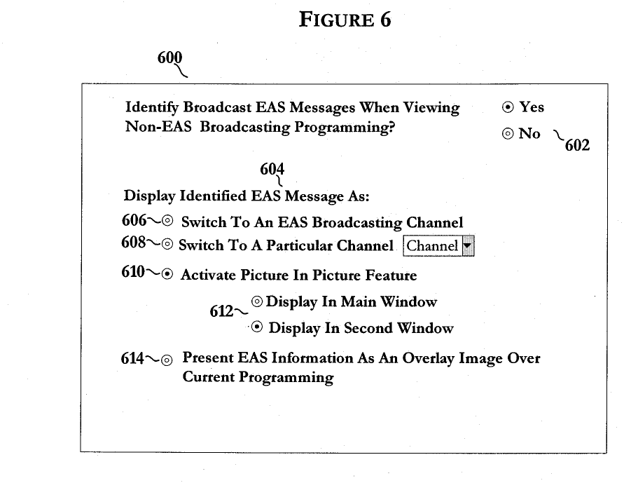

With reference now to FIG. 6, an example of a user interface 600 for providing a user configurable option for displaying emergency alert system message in accordance with the disclosed embodiments is presented. In the depicted embodiment, user interface 600 includes a user selectable option 602 for identifying the emergency alert system message when viewing programming that does not include the emergency alert system message. In addition, in some embodiments, user interface 600 includes a user configurable option 604 for displaying the emergency alert system message. For example, in one embodiment, user configurable option 604 may include an option 606 to switch from a current programming to a broadcasting channel that includes the emergency alert system message. Additionally, in some embodiments, user configurable option 604 may include an option 608 to switch from a current programming to a user specified channel. For example, a user may prefer a particular news channel. In some embodiments, user configurable option 604 may also include an option 610 to activate a picture-in-picture feature associated with a coupled display unit for displaying a channel that includes the emergency alert system message. In these embodiments, option 610 may include an option 612 for displaying the emergency alert system message in the main window or in the second opened window. Further, in some embodiments, user configurable option 604 may include an option 614 for presenting information associated with the emergency alert system message as an overlay image over a current program.

Accordingly, embodiments of the disclosed invention include a system and a method for displaying an emergency alert message. In one embodiment, a set top box is disclosed that identifies an emergency alert system message and determines whether the set top box is currently tuned to a channel that includes displaying of the identified emergency alert system message. In response to a determination that the set top box is not currently tuned to a channel that includes displaying of the identified emergency alert system message, the set top box retrieves a set of stored user preferences and determines whether to display the identified emergency alert system message based on the retrieved user preferences. In response to a determination to display the identified emergency alert system message based on the retrieved user preferences, the set top box displays the identified emergency alert system message on the display unit in accordance with the user specified preferences.

As will be appreciated by one skilled in the art, the disclosed embodiments may be embodied as a system, method, or computer program product. Accordingly, the disclosed embodiments may be implemented entirely with hardware or as a software embodiment (including firmware, resident software, micro-code, etc.) or an embodiment combining software and hardware aspects that may all generally be referred to herein as a “circuit,” “module” or “system.” Furthermore, the disclosed embodiments may take the form of a computer program product embodied in any tangible medium of expression having computer-usable program code embodied in the medium.

Computer program code for carrying out operations of the present invention may be written in any combination of one or more programming languages, including an object oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated.

In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

We claim:

1. A set top box for providing a user configurable option for displaying an emergency alert message on a display unit, the set top box comprising:
a memory component for storing computer executable instructions;
a communication interface for receiving data from a media content provider;
a decoder module for decoding the received data;
an emergency alert message identification module for identifying an emergency alert message from the received data;
a data storage unit for storing media content files and user preferences associated with displaying of the identified emergency alert message;
a processing unit that executes the computer executable instructions to:
determine whether the set top box is currently tuned to a channel that includes displaying of the identified emergency alert message;
responsive to a determination that the set top box is not currently tuned to a channel that includes displaying of the identified emergency alert message, retrieve the stored user preferences;
determine whether to display the identified emergency alert message based on the retrieved user preferences; and
responsive to a determination to display the identified emergency alert message based on the retrieved user preferences, display the identified emergency alert message on the display unit.

2. The set top box of claim 1, wherein displaying the identified emergency alert message on the display unit includes tuning the set top box to a channel that includes the identified emergency alert message.

3. The set top box of claim 1, wherein displaying the identified emergency alert message on the display unit includes tuning the set top box to a user specified channel that includes the identified emergency alert message.

4. The set top box of claim 1, further comprising:
a picture-in-picture controller module for activating a second display window associated with the display unit; and wherein the processing unit further executes the computer executable instructions to display a channel containing the identified emergency alert message on the second display window associated with the display unit.

5. The set top box of claim 1, further comprising:
an emergency alert overlay module for generating an overlay interface containing information associated with the identified emergency alert message; and wherein the processing unit further executes the computer executable instructions to display the generated overlay interface over a portion of a current program on the display unit.

6. The set top box of claim 5, wherein the current program on the display unit is a stored media content file.

7. The set top box of claim 5, wherein the current program on the display unit is a channel that is not encoded with the identified emergency alert message.

8. The set top box of claim 1, further comprising:
a digital video recorder controller module for switching from the playback of a stored media content file to a channel that includes displaying of the identified emergency alert message.

9. A method performed by a set top box for displaying an emergency alert, the method comprising:
receiving media content data from a broadcasting station;
identifying from the media content data an emergency alert message;
determining whether the set top box is tuned to a channel that includes the emergency alert message;
responsive to a determination that the set top box is not tuned to a channel that includes the emergency alert message; retrieving user preferences associated with displaying the emergency alert message;
determining from the user preferences whether to display the emergency alert message; and
responsive to a determination to display the emergency alert message, displaying the emergency alert message on a display unit coupled to the set top box.

10. The method of claim 9, wherein displaying the emergency alert message on the display unit includes tuning the set top box to a channel that includes displaying of the identified emergency alert message.

11. The method of claim 9, further comprising:
activating a second display window associated with the display unit; and
displaying a channel containing the emergency alert message on the second display window.

12. The method of claim 9, further comprising:
generating an overlay interface containing information associated with identified emergency alert message; and
displaying the generated overlay interface over a portion of a current program on the display unit.

13. The method of claim 12, further comprising updating the displayed generated overlay interface with updated information associated with the emergency alert message.

14. The method of claim 13, further comprising closing the displayed generated overlay interface in response to receiving an end of message indicator associated with the emergency alert message.

15. A user interface for providing a user configurable option for displaying an emergency alert message, the user interface comprising:
a user selectable option for identifying the emergency alert message when viewing a channel that does not include the emergency alert message; and
a user configurable option for displaying the emergency alert message.

16. The user interface of claim 15, wherein the user configurable option for displaying the emergency alert message includes an option to switch from a current programming to a broadcasting channel that includes the emergency alert message.

17. The user interface of claim 15, wherein the user configurable option for displaying the emergency alert message includes an option to switch from a current programming to a user specified channel.

18. The user interface of claim 15, wherein the user configurable option for displaying the emergency alert message includes an option to activate a picture-in-picture feature associated with a coupled display unit for displaying a channel that includes the emergency alert message.

19. The user interface of claim 18, wherein the option to activate a picture-in-picture feature associated with a coupled display unit includes a window option for displaying a channel that includes the emergency alert message in the second opened window.

20. The user interface of claim 15, wherein the user configurable option for displaying the emergency alert message includes an option for presenting information associated with the emergency alert message as an overlay image over a current program.
